(19) United States
(12) Patent Application Publication
(10) Pub. No.: US 2026/0288170 A1
(43) Pub. Date: Sep. 24, 2026

(54) METHOD AND SYSTEM FOR CONTROLLING A ROBOT

(71) Applicant: Bear Robotics, Inc., Redwood City, CA (US)

(72) Inventors: Trung NGUYEN, Mesquite, TX (US); Kevin RABIDEAU, Redwood City, CA (US)

(73) Assignee: Bear Robotics, Inc., Redwood City, CA (US)

(21) Appl. No.: 19/473,346

(22) PCT Filed: Apr. 5, 2024
(86) PCT No.: PCT/US2024/023308

§ 371 Date: Oct. 7, 2025

Related U.S. Application Data
(60) Provisional application No. 63/458,212, filed on Apr. 10, 2023.

(51) Int. Cl. G05D 1/693; G05D 1/622; G05D 109/10

(52) U.S. Cl. CPC G05D 1/693; G05D 1/622; G05D 2109/10

(57) ABSTRACT

According to one aspect of the present invention, there is provided a method for controlling a robot, the method comprising the steps of: aggregating travel routes of a plurality of robots to determine an overlap region where the travel routes of the plurality of robots overlap; and determining a robot to have a right of passage over the overlap region.

### CROSS-REFERENCE TO RELATED APPLICATIONS

This application claims the benefit of U.S. Provisional Application No. 63/458,212 filed on Apr. 10, 2023, the entire contents of which are herein incorporated by reference.

### FIELD OF THE INVENTION

The present invention relates to a method and system for controlling a robot.

### BACKGROUND

There is a known approach to determining a travel route of a robot where a user directly specifies the travel route of the robot. However, this approach has limitations in that the robot cannot respond to situational changes. For example, if an unexpected obstacle is located in the travel route specified by the user, the robot will no longer be able to move toward a destination. Further, the approach has problems in that it requires human labor and has less scalability of use.

### SUMMARY OF THE INVENTION

One object of the present invention is to solve all the above-described problems in the prior art.

Another object of the invention is to enable robots to navigate autonomously and determine an overlap region where travel routes of multiple robots overlap, so that the robots can resiliently respond to changes in navigational situations.

The representative configurations of the invention to achieve the above objects are described below.

According to one aspect of the invention, there is provided a method for controlling a robot, the method comprising the steps of: aggregating travel routes of a plurality of robots to determine an overlap region where the travel routes of the plurality of robots overlap; and determining a robot to have a right of passage over the overlap region.

According to another aspect of the invention, there is provided a system for controlling a robot, the system comprising: a first determination unit configured to aggregate travel routes of a plurality of robots to determine an overlap region where the travel routes of the plurality of robots overlap; and a second determination unit configured to determine a robot to have a right of passage over the overlap region.

In addition, there are further provided other methods and systems to implement the invention, as well as non-transitory computer-readable recording media having stored thereon computer programs for executing the methods.

According to the invention, it is possible to enable robots to navigate autonomously and determine an overlap region where travel routes of multiple robots overlap, so that the robots can resiliently respond to changes in navigational situations.

### BRIEF DESCRIPTION OF THE DRAWINGS

FIG. 1 schematically shows the configuration of an entire system for controlling a robot according to one embodiment of the invention.

FIG. 2 illustratively shows the structure of a robot according to one embodiment of the invention.

FIG. 3 illustratively shows the structure of a robot according to one embodiment of the invention.

FIG. 4 specifically shows the internal configuration of a robot control system according to one embodiment of the invention.

FIGS. 5A and 5B illustratively show how to determine an overlap region according to one embodiment of the invention.

FIG. 6 illustratively shows how to determine a robot to have a right of passage over an overlap region according to one embodiment of the invention

FIG. 7 illustratively shows how to determine a robot to have a right of passage over an overlap region according to one embodiment of the invention

FIGS. 8A to 8C illustratively show how to determine a robot to have a right of passage over an overlap region according to one embodiment of the invention.

### DETAILED DESCRIPTION OF THE INVENTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures and characteristics described herein may be implemented as modified from one embodiment to another without departing from the spirit and scope of the invention. Furthermore, it shall be understood that the positions or arrangements of individual elements within each embodiment may also be modified without departing from the spirit and scope of the invention. Therefore, the following detailed description is not to be taken in a limiting sense, and the scope of the invention is to be taken as encompassing the scope of the appended claims and all equivalents thereof. In the drawings, like reference numerals refer to the same or similar elements throughout the several views.

Hereinafter, various preferred embodiments of the present invention will be described in detail with reference to the accompanying drawings to enable those skilled in the art to easily implement the invention.

### Configuration of the Entire System

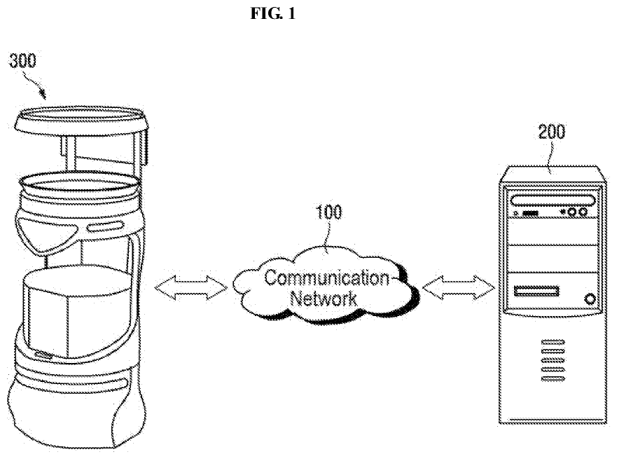

FIG. 1 schematically shows the configuration of the entire system for controlling a robot according to one embodiment of the invention.

As shown in FIG. 1, the entire system according to one embodiment of the invention may comprise a communication network 100, a robot control system 200, and a robot 300.

First, the communication network 100 according to one embodiment of the invention may be implemented regardless of communication modality such as wired and wireless communications, and may be constructed from a variety of communication networks such as local area networks (LANs), metropolitan area networks (MANs), and wide area networks (WANs). Preferably, the communication network 100 described herein may be the Internet or the World Wide Web (WWW). However, the communication network 100 is not necessarily limited thereto, and may at least partially include known wired/wireless data communication networks, known telephone networks, or known wired/wireless television communication networks.

For example, the communication network 100 may be a wireless data communication network, at least a part of which may be implemented with a conventional communication scheme such as WiFi communication, WiFi-Direct communication, Long Term Evolution (LTE) communication, 5G communication, Bluetooth communication (including Bluetooth Low Energy (BLE) communication), infrared communication, and ultrasonic communication. As another example, the communication network 100 may be an optical communication network, at least a part of which may be implemented with a conventional communication scheme such as LiFi (Light Fidelity).

Next, the robot control system 200 according to one embodiment of the invention may function to aggregate travel routes of a plurality of robots 300 to determine an overlap region where the travel routes of the plurality of robots 300 overlap, and determine a robot 300 to have a right of passage over the overlap region.

The configuration and functions of the robot control system 200 according to the invention will be discussed in more detail below.

Next, the robot 300 according to one embodiment of the invention is a device capable of communicating with the robot control system 200 via the communication network 100 and performing predetermined functions or assigned tasks (e.g., serving food and retrieving containers) through communication with the robot control system 200, and may include a support configured to support at least one object. The robot 300 according to one embodiment of the invention may include at least one of a module (e.g., a grab or a robotic arm module) for loading and unloading an object (e.g., a food tray), an imaging module (e.g., a visible light camera or an infrared camera) for acquiring images of surroundings, a scanner module (e.g., a LIDAR sensor) for acquiring information on obstacles, a sound acquisition module (e.g., a microphone) for acquiring sounds of surroundings, an illuminance acquisition module (e.g., an illuminance sensor) for sensing brightness of surroundings, a speaker module for providing sound information, a display module (e.g., LCD) for providing visual information such as text information, a light emitting module (e.g., LED) for providing visual information such as color information, and a drive module (e.g., a motor) for moving the robot 300.

For example, the robot 300 may have characteristics or functions similar to those of at least one of a serving robot, a guide robot, a transport robot, a cleaning robot, a medical robot, an entertainment robot, a pet robot, and an unmanned flying robot. Meanwhile, supporting of an object herein should be interpreted as encompassing supporting of a container for containing an object such as food, a means where the container may be placed (e.g., a tray), or the like.

Meanwhile, according to one embodiment of the invention, the robot 300 may include an application (not shown) for controlling the robot 300 according to the invention. The application may be downloaded from the robot control system 200 or an external application distribution server (not shown). According to one embodiment of the invention, the characteristics of the application may be generally similar to those of a first determination unit 210, a second determination unit 220, a communication unit 230, and a control unit 240 of the robot control system 200 to be described below. Here, at least a part of the application may be replaced with a hardware device or a firmware device that may perform a substantially equal or equivalent function, as necessary.

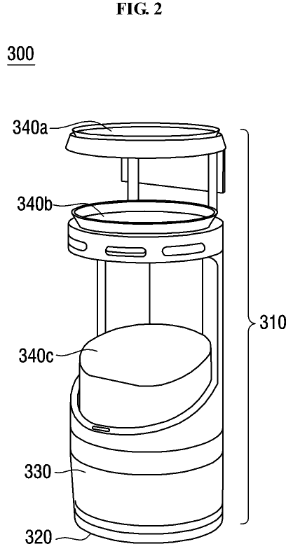

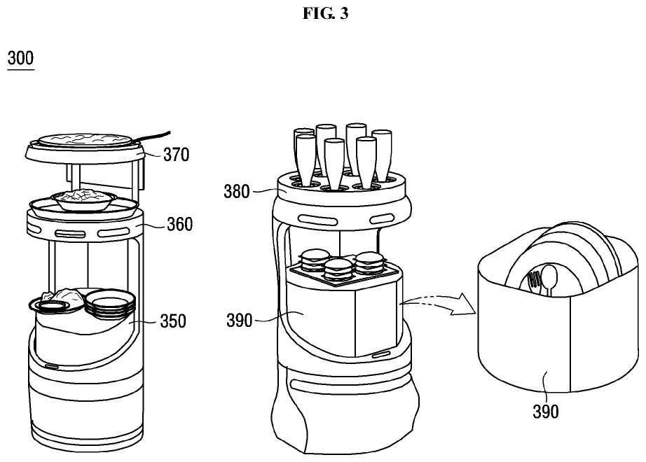

FIGS. 2 and 3 illustratively show the structure of the robot 300 according to one embodiment of the invention.

Referring to FIG. 2, the robot 300 may comprise a main body 310, a drive unit 320, and a processor 330.

First, the main body 310 according to one embodiment of the invention may be coupled to supports 340a, 340b, and 340c configured to support at least one object. According to one embodiment of the invention, the supports 340a, 340b, and 340c may be removably coupled for cleaning, replacement, or the like. Further, each of the supports 340a, 340b, and 340c may include a weight sensor (not shown) for sensing a weight supported by each of the supports 340a, 340b, and 340c. According to one embodiment of the invention, the weight sensor may be implemented using one or more strain gauges (e.g., three strain gauges, four strain gauges, or the like). In addition, according to one embodiment of the invention, the weight sensor may be coupled to the processor 330.

Further, the main body 310 according to one embodiment of the invention may include a photographing module (not shown) configured to face a spatial region above each of the supports 340a, 340b, and 340c, in place of or in addition to the weight sensor. Meanwhile, according to one embodiment of the invention, the photographing modules configured to face the spatial regions above the respective supports 340a, 340b, and 340c are not necessarily included in the main body 310, and at least some of the photographing modules may be installed on a structure in a serving place.

Meanwhile, the main body 310 according to one embodiment of the invention may include at least one loading space for loading an object. Further, according to one embodiment of the invention, the at least one loading space may include the supports 340a, 340b, and 340c. The object according to one embodiment of the invention may refer to all material objects that can be moved by the robot 300, and may encompass things, animals, and the like. For example, the object according to one embodiment of the invention may include a serving object such as food and a bussing object such as a container containing the food.

Referring to FIG. 3, the robot 300 according to one embodiment of the invention may include a first space 350 and a second space 360 for providing a serving object (i.e., serving) and collecting a bussing object (i.e., bussing). Further, the robot 300 may further include a third space 370 that is an expansion space provided via a removable pillar, and more loading spaces may be provided by adding more expansion spaces as needed. Further, the robot 300 may further include a tray 380 dedicated for the serving object or the bussing object. For example, the tray 380 may be configured such that a plurality of circular grooves are formed on its top side as seen from the top. Each of the circular grooves may be formed such that the lower part of a cup containing a drink is seated and easily fixed to some extent. The sizes of the circular grooves may be diverse. Further, the lower part of the first space 350 of the robot 300 may include a fourth space 390 that may be taken out through a lateral side of the robot 300. The fourth space 390 according to one embodiment of the invention may have a shape similar to a basket, such that an empty space is formed therein; a lateral side thereof is closed; a top side thereof is open; and a bottom side thereof is closed. However, the loading spaces of the robot 300 according to the invention are not necessarily limited to the above description, and may be diversely implemented as other types of loading spaces as long as the objects of the invention may be achieved.

Next, referring to FIG. 2 again, the drive unit 320 according to one embodiment of the invention may comprise a module for moving the main body 310 to other locations. For example, the drive unit 320 may include a module related to electrically, mechanically, or hydraulically driven wheels, propellers, or the like as the module for moving the main body 310 to other locations.

Next, the processor 330 according to one embodiment of the invention may be electrically connected to the drive unit 320 to perform a function of controlling the drive unit 320 (and may include a communication module for communicating with an external system). For example, the processor 330 may be a data processing device that are embedded in hardware and have circuits physically structured to perform codes included in a program or functions represented by instructions. For example, such a data processing device embedded in hardware may include a processing device such as a microprocessor, a central processing unit, a processor core, a multiprocessor, an application-specific integrated circuit (ASIC), and a field programmable gate array (FPGA).

Further, the processor 330 may perform the functions of at least one of the first determination unit 210 and the second determination unit 220 of the robot control system 200 according to the invention (e.g., the corresponding functions may be modularized and included in the processor 330), and may function to control the drive unit 320 through communication with an external system (not shown) that performs the functions of at least one of the first determination unit 210 and the second determination unit 220.

Specifically, the processor 330 may function to aggregate travel routes of a plurality of robots 300 to determine an overlap region where the travel routes of the plurality of robots 300 overlap, and determine a robot 300 to have a right of passage over the overlap region.

### Configuration of the Robot Control System

Hereinafter, the internal configuration of the robot control system 200 crucial for implementing the invention and the functions of the respective components thereof will be discussed.

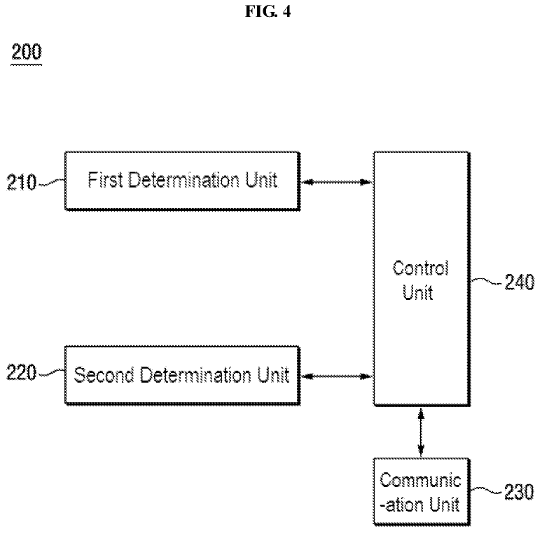

FIG. 4 specifically shows the internal configuration of the robot control system 200 according to one embodiment of the invention.

As shown in FIG. 4, the robot control system 200 according to one embodiment of the invention may comprise a first determination unit 210, a second determination unit 220, a communication unit 230, and a control unit 240. According to one embodiment of the invention, at least some of the first determination unit 210, the second determination unit 220, the communication unit 230, and the control unit 240 may be program modules that communicate with an external system. The program modules may be included in the robot control system 200 in the form of operating systems, application program modules, and other program modules, while they may be physically stored in a variety of commonly known storage devices. Further, the program modules may also be stored in a remote storage device that may communicate with the robot control system 200. Meanwhile, such program modules may include, but are not limited to, routines, subroutines, programs, objects, components, and data structures for performing specific tasks or executing specific abstract data types according to the invention as will be described below.

Meanwhile, the above description is illustrative although the robot control system 200 has been described as above, and it will be apparent to those skilled in the art that at least a part of the components or functions of the robot control system 200 may be implemented or included in the robot 300 or an external system (not shown), as necessary. Further, in some cases, all of the functions and components of the robot control system 200 may be implemented or included in the robot 300.

First, according to one embodiment of the invention, the first determination unit 210 may function to aggregate travel routes of a plurality of robots 300 to determine an overlap region where the travel routes of the plurality of robots 300 overlaps.

According to one embodiment of the invention, the robot 300 may be configured to essentially navigate autonomously in a space. The autonomous navigation may be accomplished by utilizing a scanner module and/or an imaging module provided in the robot 300. Specific methods for implementing the autonomous navigation may employ a variety of techniques including those known in the art. Hereinafter, the present invention will be described on the premise that the robot 300 autonomously navigates in a space.

According to one embodiment of the invention, a plurality of robots 300 may be traveling in a space and at least a part of the travel routes of the respective robots 300 may overlap. The first determination unit 210 may aggregate the travel routes of the plurality of robots 300 and then determine a region where the travel routes of the plurality of robots 300 overlap as an overlap region. Here, each robot 300 may change its original travel route to a different travel route depending on navigational situations while traveling in the space, and the first determination unit 210 may aggregate the travel routes even in such cases to determine (or redetermine) the overlap region. That is, the first determination unit 210 may aggregate the travel routes of the plurality of robots 300 in real time to determine the overlap region.

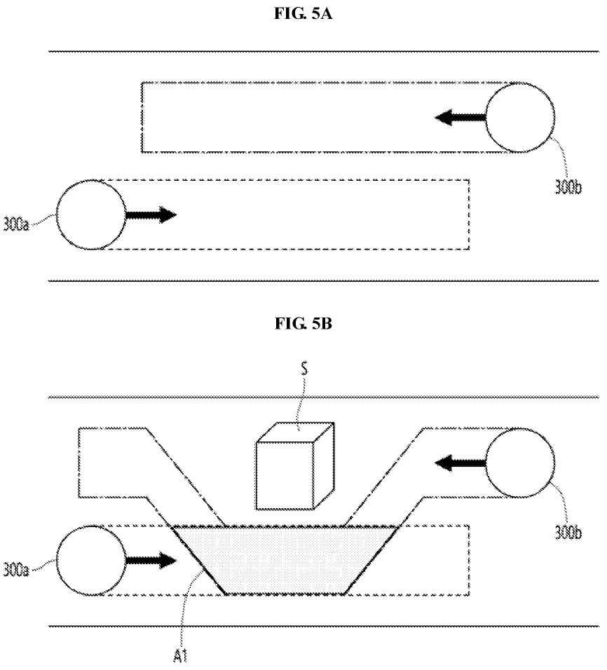

For example, referring to FIGS. 5A and 5B, travel routes of a first robot 300a and a second robot 300b do not overlap initially (see FIG. 5A), but an unexpected obstacle S may be located in the travel route of the second robot 300b (see FIG. 5B). The travel route of the second robot 300b may change in this case, and this route change may cause the travel routes of the first robot 300a and the second robot 300b to overlap in a region A1. As a result, the first determination unit 210 may aggregate the travel routes of the first robot 300a and the second robot 300b in real time to determine the region A1 as an overlap region.

Next, according to one embodiment of the invention, the second determination unit 220 may function to determine a robot 300 to have a right of passage over the overlap region.

According to one embodiment of the invention, a deadlock situation may occur when the plurality of robots 300 are located in the overlap region. Thus, in such cases, it may be desirable that only one robot 300 has a right of passage over the overlap region. In consideration of the foregoing, when an overlap region is determined by the first determination unit 210, the second determination unit 220 may determine that only one robot 300 has a right of passage over the overlap region.

Specifically, according to one embodiment of the invention, in response to all of the plurality of robots 300 being located outside the overlap region, the second determination unit 220 may determine that only one of the plurality of robots 300 has a right of passage over the overlap region. Here, only robots 300 located within a predetermined distance from the overlap region among the plurality of robots 300 may be eligible to have the right of passage. That is, when any robot 300 is located outside the overlap region but located beyond the predetermined distance from the overlap region, the robot 300 may not be eligible to have the right of passage.

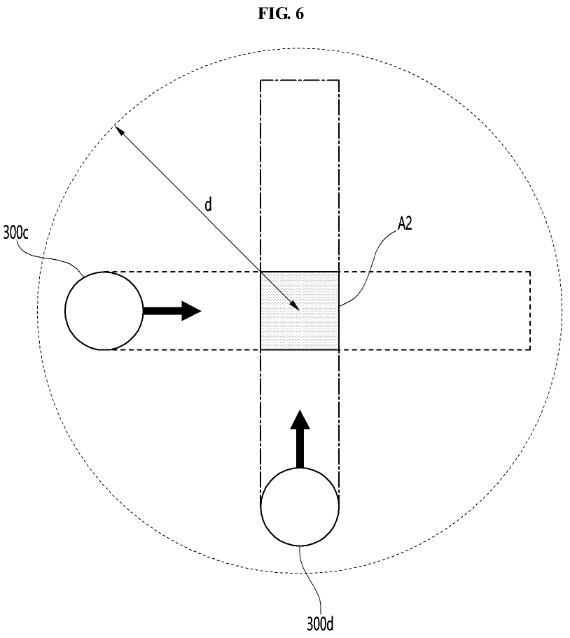

For example, referring to FIG. 6, in response to a third robot 300c and a fourth robot 300d being located outside an overlap region A2 but located within a predetermined distance d from the overlap region A2, the second determination unit 220 may determine that only one of the third robot 300c and the fourth robot 300d has a right of passage over the overlap region A2. Here, it is possible to determine which of the third robot 300c and the fourth robot 300d has the right of passage over the overlap region A2 in consideration of a distance of each robot from the overlap region A2, a speed of each robot, a task importance of each robot, and the like.

Further, according to one embodiment of the invention, in response to any one of the plurality of robots 300 being located in the overlap region, the second determination unit 220 may determine that only the robot 300 located in the overlap region has a right of passage over the overlap region. Here, the second determination unit 220 may determine that the robots 300 other than the robot 300 located in the overlap region have the right of passage over the overlap region after the robot 300 located in the overlap region leaves the overlap region.

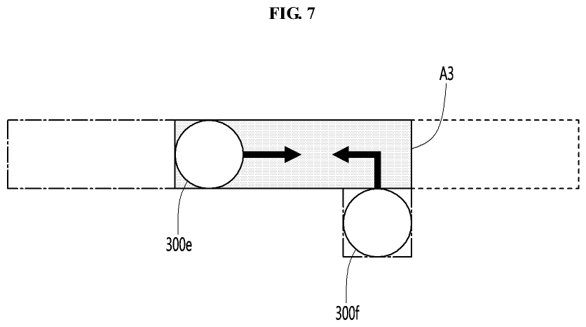

For example, referring to FIG. 7, in response to, among a fifth robot 300e and a sixth robot 300f, the fifth robot 300e being located in an overlap region A3, the second determination unit 220 may determine that only the fifth robot 300e located in the overlap region A3 has a right of passage over the overlap region A3. Here, the second determination unit 220 may determine that the sixth robot 300f not located in the overlap region A3 has the right of passage over the overlap region A3 after the fifth robot 300e located in the overlap region A3 leaves the overlap region A3.

Further, according to one embodiment of the invention, in response to at least two of the plurality of robots 300 being located in the overlap region, the second determination unit 220 may determine that only one of the at least two robots 300 has a right of passage over the overlap region. Here, the second determination unit 220 may determine that the robot 300 that does not have the right of passage and is caused to leave the overlap region has the right of passage over the overlap region after the robot 300 having the right of passage leaves the overlap region.

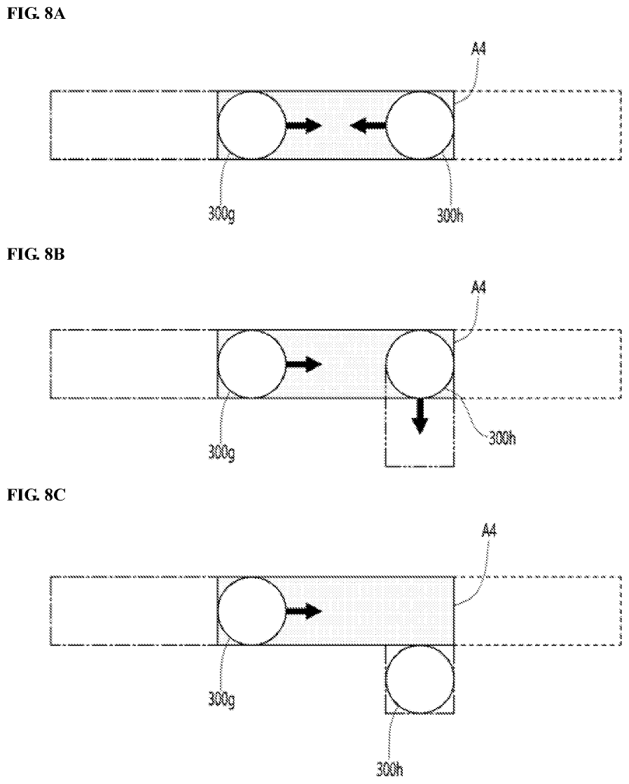

For example, referring to FIGS. 8A to 8C, in response to a seventh robot 300g and an eighth robot 300h being located in an overlap region A4, the second determination unit 220 may determine that only one of the two robots has a right of passage over the overlap region A4 (see FIG. 8A). Here, it is possible to determine which of the seventh robot 300g and the eighth robot 300h has the right of passage in consideration of a speed of each robot, a task importance of each robot, and the like. If it is determined that the seventh robot 300g has the right of passage and the eighth robot 300h does not have the right of passage, the second determination unit 220 may cause the eighth robot 300h to leave the overlap region A4 (see FIGS. 8B and 8C). Here, in causing the eighth robot 300h to leave the overlap region A4, the second determination unit 220 may cause the eighth robot 300h to travel to a point that is located outside the overlap region A4 but closest to the overlap region A4. This point may be a point that does not overlap with the travel route of the seventh robot 300g. Then, the second determination unit 220 may determine that the eighth robot 300h has the right of passage after the seventh robot 300g having the right of passage leaves the overlap region A4.

As described above, the present invention may allow the robots 300 to explore available routes on their own without forcing the robots 300 to follow particular routes. Further, the determination of the overlap region may prevent a deadlock situation from occurring between the plurality of robots 300. As a result, according to the invention, the robots 300 can resiliently respond to changes in navigational situations.

Next, the communication unit 230 according to one embodiment of the invention may function to enable data transmission/reception from/to the first determination unit 210 and the second determination unit 220.

Lastly, the control unit 240 according to one embodiment of the invention may function to control data flow among the first determination unit 210, the second determination unit 220, and the communication unit 230. That is, the control unit 240 according to one embodiment of the invention may control data flow into/out of the robot control system 200 or data flow among the respective components of the robot control system 200, such that the first determination unit 210, the second determination unit 220, and the communication unit 230 may carry out their particular functions, respectively.

The embodiments according to the invention as described above may be implemented in the form of program instructions that can be executed by various computer components, and may be stored on a computer-readable recording medium. The computer-readable recording medium may include program instructions, data files, and data structures, separately or in combination. The program instructions stored on the computer-readable recording medium may be specially designed and configured for the present invention, or may also be known and available to those skilled in the computer software field. Examples of the computer-readable recording medium include the following: magnetic media such as hard disks, floppy disks and magnetic tapes; optical media such as compact disk-read only memory (CD-ROM) and digital versatile disks (DVDs); magneto-optical media such as floptical disks; and hardware devices such as read-only memory (ROM), random access memory (RAM) and flash memory, which are specially configured to store and execute program instructions. Examples of the program instructions include not only machine language codes created by a compiler, but also high-level language codes that can be executed by a computer using an interpreter. The above hardware devices may be changed to one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

1. A method for controlling a robot, the method comprising the steps of:
(a) aggregating travel routes of a plurality of robots to determine an overlap region where the travel routes of the plurality of robots overlap; and
(b) deter mining a robot to have a right of passage over the overlap region.

2. The method of claim 1, wherein in step (a), the travel routes of the plurality of robots are aggregated in real time to determine the overlap region.

3. The method of claim 1, wherein in step (b), in response to all of the plurality of robots being located outside the overlap region, it is determined that only one of the plurality of robots has the right of passage.

4. The method of claim 1, wherein in step (b), in response to any one of the plurality of robots being located in the overlap region, it is determined that only the robot located in the overlap region has the right of passage.

5. The method of claim 4, wherein in step (b), it is determined that the robots other than the robot located in the overlap region have the right of passage after the robot located in the overlap region leaves the overlap region.

6. The method of claim 1, wherein in step (b), in response to at least two of the plurality of robots being located in the overlap region, it is determined that only one of the at least two robots has the right of passage.

7. The method of claim 6, wherein in step (b), it is determined that the robot that does not have the right of passage and is caused to leave the overlap region has the right of passage after the robot having the right of passage leaves the overlap region.

8. A non-transitory computer-readable recording medium having stored thereon a computer program for executing the method of claim 1.

9. A system for controlling a robot, the system comprising:
a first determination unit configured to aggregate travel routes of a plurality of robots to determine an overlap region where the travel routes of the plurality of robots overlap; and
a second determination unit configured to determine a robot to have a right of passage over the overlap region.

10. The system of claim 9, wherein the first determination unit is configured to aggregate the travel routes of the plurality of robots in real time to determine the overlap region.

11. The system of claim 9, wherein the second determination unit is configured to, in response to all of the plurality of robots being located outside the overlap region, determine that only one of the plurality of robots has the right of passage.

12. The system of claim 9, wherein the second determination unit is configured to, in response to any one of the plurality of robots being located in the overlap region, determine that only the robot located in the overlap region has the right of passage.

13. The system of claim 12, wherein the second determination unit is configured to determine that the robots other than the robot located in the overlap region have the right of passage after the robot located in the overlap region leaves the overlap region.

14. The system of claim 9, wherein the second determination unit is configured to, in response to at least two of the plurality of robots being located in the overlap region, determine that only one of the at least two robots has the right of passage.

15. The system of claim 14, wherein the second determination unit is configured to determine that the robot that does not have the right of passage and is caused to leave the overlap region has the right of passage after the robot having the right of passage leaves the overlap region.
